(19) United States
(12) Patent Application Publication
(10) Pub. No.: US 2002/0143800 A1
(43) Pub. Date: Oct. 3, 2002

(54) Model view controller

(76) Inventors: Henrik Lindberg, Djursholm (SE); Pontus Rydin, Grasse (FR)

Correspondence Address: DAVIDSON, DAVIDSON & KAPPEL, LLC, 14th Floor, 485 Seventh Avenue, New York, NY, 10018, US

(21) Appl. No.: 09/768,389

(22) Filed: Jan. 24, 2001

(51) Int. Cl. G06F 12/00; G06F 17/30

(52) U.S. Cl. 707/201; 707/200

(57) ABSTRACT

A system includes a server operably connected to a database which maintainins a tree of information in the database. Each node in the tree constitutes a server side model. The system further includes a client arranged and constructed to communicate with the server over the communication network via a graphical user interface such as a browser. The browser is operable to access the database and download a mirror copy of at least a portion of the relational tree along with a web page form which contains fields for receiving and/or displaying information, and optionally a controller utility. Each node in the mirror copy constitutes a client side model. In accordance with the present invention, each field has associated therewith one of the client side models. An executable process, either on the web page form and/or on the controller utility controls the manner in which the information in the client side models are displayed in their corresponding fields (or “views), and may further provide client side processing of information input to the fields by a user of the browser.

### FIELD OF THE INVENTION

This invention relates to web interfaces, and more particularly, to a web interface for accessing a relational database.

### BACKGROUND OF THE INVENTION

Databases provide a structured system for storing and retrieving information on computer based systems and networks in a quick and efficient manner. Virtually all of the information on the Internet, for example, is stored in databases.

To retrieve information from a database residing on the Internet, a user accesses the database server via a web interface, such as a browser. The browser displays a form including of a number of fields for accepting input such as search criteria. Typically, after all the input is entered, the browser sends the input to the server in the form of a request which must follow a number of syntax rules to search the database contents. For example, state abbreviations must be correct, certain information fields must have a particular number of characters, i.e., nine digits in a phone number. In addition, relationships between information must be supported, meaning that the database must have the type of information sought. In a database of car information, if BWMs are not made in blue, the relationship between the car field of BMW and the color field for blue is not supported. Therefore, if a request is submitted for a blue BMW, an error results for an unsupported relationship.

The typical web interface does not verify input field by field because this requires complex communication with the server. Instead, all input is verified by the server when submitted after all the necessary search criteria is entered. If there is an error, the server sends the request back to the browser, and a new form is pushed to the user indicating what must be changed or added. After the user makes the necessary modifications, the corrected request is sent back to the server again.

### SUMMARY OF THE INVENTION

In accordance with an embodiment of the present invention, a system includes a server operably connected to a database that maintains a tree of information in the database. Each node in the tree constitutes a server side model. The system further includes a client arranged and constructed to communicate with the server over the communication network via a browser. The browser is operable to access the database and download a mirror copy of at least a portion of the tree along with a web page form which contains fields for receiving and/or displaying information, and optionally a controller utility. Each node in the mirror copy constitutes a client side model. In accordance with this embodiment, each field has associated therewith one of the client side models. An executable process, either on the web page form and/or on the controller utility controls the manner in which the information in the client side models are displayed in their corresponding fields (or “views”), and may further provide client side processing of information input to the fields by a user of the browser. It should be noted that although each field on the web page form (e.g., an HTML form) must have a corresponding model, a single model may drive a plurality of fields. The executable process, in accordance with instructions contained in web page form, can update the server side model to reflect changes made to the client side models

The executable process is preferably operable to verify selected inputs to the fields and navigation of the form by referencing and modifying the information in the client side model, without the need to communicate over the Internet with the corresponding server side models. As an example, the executable process might be operable to verify address and telephone number syntax on an HTML form without accessing a web server. In such an example, data input into the field of the form (the views) could be checked for proper syntax on the browser by the executable process, and if the syntax is found acceptable, the executable process could store the input information in the client side models corresponding to the views. This updated information in the client side model could then be used by the executable process to modify other views (e.g., automatically conforming the time zone listed in another view based upon the area code in the telephone number). In any event, once the user has completed all the entries in the form, and has pressed a “submit” button, the executable process would transmit the changes in the client side model (e.g., the information input by the user into the fields on the form) over the Internet to the server side model for further processing.

In accordance with another embodiment of the present invention, the system is directed more generally to a system for verifying input between a graphical user interface and a database over a communication network. The system includes a server operably connected to a database, the database maintaining a tree of information in the database, each node in the relational tree constituting a server side model. A client is arranged and constructed to communicate with the server over the communication network. The client has a graphical user interface executable by the computer to: access the database; download a mirror copy of at least a portion of the tree, each node in the mirror copy constituting a client side model; display a form containing one or more fields for receiving and/or displaying information, each field being associated with one of the client side models; change at least one of the client side models based upon information input to the fields, and update the server side model with said changes. In accordance with farther aspects of this embodiment of the present invention, the graphical user interface is implemented as one of a Swing interface, an AWT interface, and a Windows interface. In this regard, for example, the Swing and AWT interfaces could be implemented in JAVA, and the Windows interface could be implemented in C++.

### BRIEF DESCRIPTION OF THE DRAWINGS

FIG. 1 depicts a model for a database mapping according to the present invention.

FIG. 2 shows a communication network.

FIG. 3 depicts an exemplary form for the model of FIG. 1.

FIG. 4 shows an illustrative system in accordance with a preferred embodiment of the present invention.

FIG. 5 illustrates an exemplary model tree in accordance with an embodiment of the present invention.

FIGS. 6(a-b) illustrate an exemplary web pages for use with a model-view controller for the model of FIG. 5.

FIG. 7 depicts another exemplary web page form for use with a model-view controller depicted in FIG. 4.

### DETAILED DESCRIPTION OF THE PREFERRED EMBODIMENTS

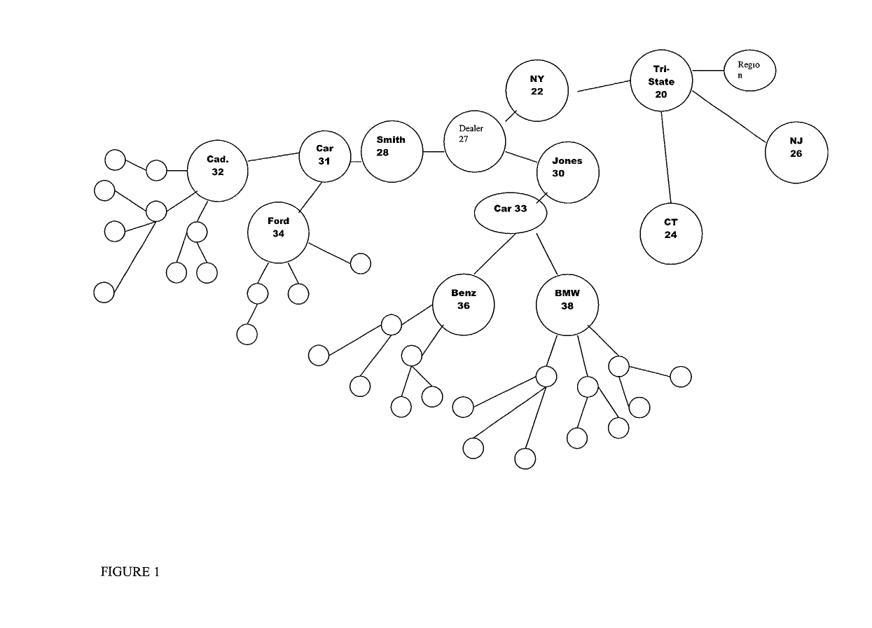

Referring to FIG. 1, there is shown a relational mapping for a database. Each circle represents a node with some information. The lines represent a relationship between two nodes, or two pieces of information.

The mapping of FIG. 1 illustrates a database that stores information for car dealership inventories in specific geographical areas. The map or model tree in FIG. 1 can be a portion of a larger database covering the United States. At the top of the model tree, a node (or model) 10 represents a Region 10, having sub-node 20 representing the tri-state area. Below this are respective nodes of New York 22, New Jersey 26 and Connecticut 24. Branching off of each state node is a dealership node 27 branching out to the dealerships in each state. In this case, only the dealerships in New York are shown. Smith 28 and Jones 30 are the two dealerships in the database for New York. Under each node for the dealerships are additional nodes for the makes of cars (nodes 31, 33) the dealerships carry. Smith 28 carries Cadillac 32 and Ford 34. Jones carries BMW, represented by node 38, and Mercedes-Benz, represented by node 36. Under each car make node are nodes 40 for the models of each make that are available at the corresponding dealerships. Each node 40 corresponds to a different model of car under its respective make node. For example, the nodes 40 under the Cadillac node 32 may correspond to a Seville, Eldorado and an Escalade, different models of the Cadillac make. The model nodes 40 are further broken down into features, or options 42, for each model. The mapping can be designed to go on to the smallest details to include color, size, specifications and any other characteristic a car may have. Business transaction information, such as inventory levels, taxes, and destination charges may be maintained in the database as well.

Lines connecting a node indicate a supported relationship. For example, the line 23 between the NY node 22 and the Smith node 28 indicates that there is a Smith dealership in New York. The line 29 between Smith 28 and GM 32 indicates that GM cars are available at the Smith dealership. There is no line between the Smith node 28 and the node for Mercedes-Benz 36 because that make of car is not available at the Smith dealership. Therefore a relationship between Smith 28 and Mercedes-Benz 36 is not supported.

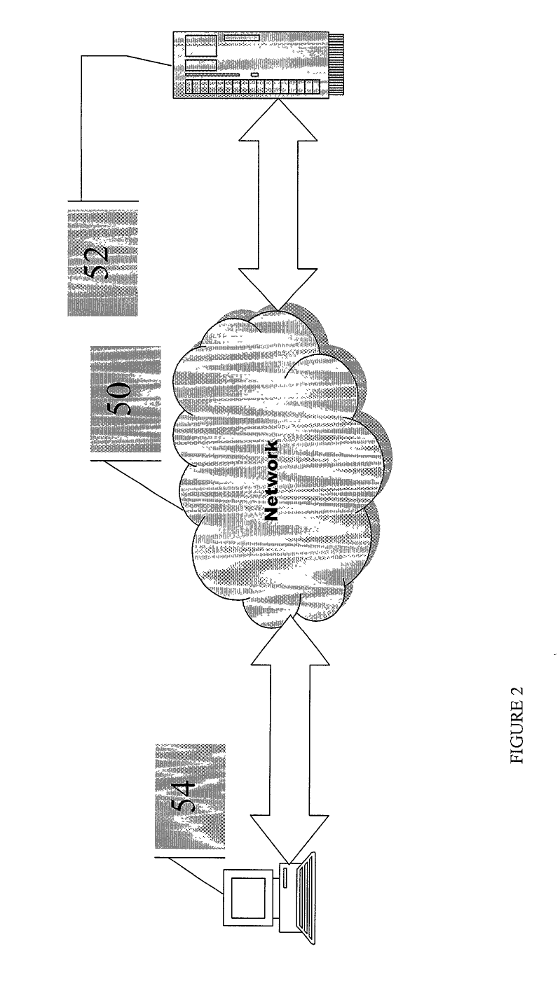

FIG. 2 depicts a diagram of a communication system. A communication network 50 provides connectivity between a server 52 and a user terminal 54. A database with the mapping of FIG. 1 resides on the server 52. A system interface for extracting information from the database resides on the terminal 54. The illustrated system may, for example, use the Internet for the network 50, a web site on the server 52, and a web browser for the user interface residing on the terminal 54.

A conventional model view controller (MVC), as used for example, in SmallTalk, has three elements, the view, the model and the controller. The view element deals with the presentation of data by rendering an image on the display of the terminal 54 and is signaled when data changes to make the appropriate change in the view corresponding to the changed data. The view can be any observer. In other words, a view doesn't necessarily need to be displayed on the user interface. It can be any object which responds to changes in a model. In this regard, it could be an intermediate object which can be linked with multiple models or views to create a transformation pipeline. As an example, the observer could be a model observing perhaps many different other models and presenting some aggregate result. The model element holds the underlying data and can have multiple views. When the model changes, it signals all its dependent views that it has changed and the dependent views then pick up the new data. The model is constructed to be independent of the number of views and any view related responsibilities. The controller translates events into actions. Typical events in a user interface are keyboard key-press events and mouse clicks. The controller translates the event into an operation such as insert-character, scroll, highlight etc.

The MVC according to the present invention provides an integrated system for communication between the browser and the server 52 wherein both the browser and the server 52 maintain mirrored models, or database mappings, and an MVC software function library facilitates communication between the display at the terminal 54 (the views), the browser side model, and the server side model. In effect, processing is conveniently allocated and distributed between the browser and the server, while still maintaining data integrity. Preferably, the client side is implemented with an object-oriented programming (OOP) language software object running in the browser and communicating with the server via a hidden form using regular HTTP only without the need for special applets or arrangements. Only content is passed between the browser and server so that all processing concerns are separated and isolated to the browser side and the server side.

A framework of library functions provide a foundation. The visual elements that function as views are configured by adding the necessary event handlers and methods. The view is linked to its corresponding model object which is either a browser contained model, or a proxy (copy) model for a real model existing on the server. Models provide verification of model values whenever an attempt is made to change it. In accordance with the present invention, verification can be performed by the model instead of the server, creating a more efficient verification process because the number of roundtrips from browser to server is reduced. The framework collects all changes made by the user, and creates a changelist so that when the user is done editing, the browser only sends the modified data back to the server for further validation and processing.

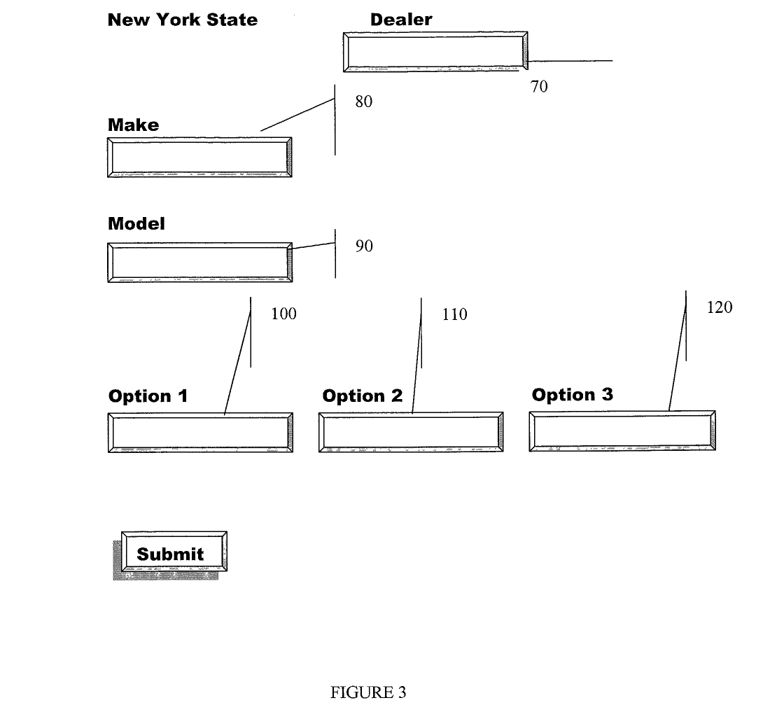

When a user initializes the web browser from the terminal 54 and accesses the database on the server 52, a graphical user interface (GUI) is displayed by the browser on the display of the terminal 54. This interface serves as the view and is linked to the browser side mirrored model. Each view may only have one model. One model, however, may have a number of different views because the information in a model may be represented in a number of different ways. The model (both server and browser) can be used for a plurality of “views”, with the MVC library, in conjunction with the model, updating the views. The views are contained within a form with fields of information entered by the user to, for example, search the database and return specific information. It should be noted that the models and views can either be manually coded, or generated via XML automatically. In accordance with a preferred embodiment of the present invention, each time the browser goes to a new web page, a local mirror copy of the relevant portion of the database model that corresponds to the views on the web page is downloaded from the server and maintained on the terminal 54. This eliminates the need to check with the server for trivial matters, such as supported relationships and syntax, and makes it possible to stay on the form and verify input without communicating with the server. For example, referring to the model of FIG. 2, when the browser is directed to the database web-page residing on the server for New York state dealerships, a copy of the portion of model in FIG. 1 beginning with node 22 is downloaded to the browser. FIG. 3 shows such an exemplary web-page (e.g., an HTML form). Six views are shown on the web page: text boxes for information on dealer 70, make 80, model 90 and three boxes for options, option 1 100, option 2 110, and option 3 120. Additional information fields may be added, such as clickable elements, like selection circles and buttons. A software developer ordinarily skilled in the art will appreciate that the view of FIG. 3 may be configured in a number of ways. For simplicity, assume that the particular configuration of the view requires an initial entry for the dealer field only so that blank boxes indicate desired information and will return all possible values for the blank information fields. For example, entering “Smith” in the dealer field 70 and leaving the other fields blank, will return all the information below the smith node 28 including the makes and models they carry and the options available on the particular models listed. Additionally entering the make 80 with “NY” will list the dealerships with the specified make selected in New York. In other words, entering “BMW” will return “Jones” with the makes available and their corresponding options because the make field 80 and the option boxes 100, 110, 120 were left blank.

When a user directs his browser to the view of FIG. 3, the browser communicates with the server to download the page and a local mirror copy of the mapping in FIG. 1. Once the browser has its local mirror copy, it can perform certain processes without the aid of the server, such as verification, thereby reducing traffic and demands on the server and freeing server resources for other uses.

As the user enters information into the boxes by entering text directly or by selecting information from a pull-down menu, the browser can (if configured to do so) verify each selection with its local model. When the user enters a dealer in the box 70, the browser checks its local model to ensure that the entry is valid, i.e., the selected dealer is in the database. The same verification is done for all fields as the user enters information. In addition, as selections are made, corresponding fields that are affected are adjusted accordingly. For example, a selection of “Smith” for dealer will change the allowed selections for the model box 90 to Cadillac and Ford because those are the only makes available from Smith according to the database. So if an invalid selection is made, the user is notified and the error is corrected by checking the local browser model without having to communicate with the server.

Alternatively, the browser can refresh the web page each time information is entered to provide updated pull-down menus or check boxes which display only valid options.

Certain selections or actions taken by the user may cause a change in the model and therefore, a change in a view condition (e.g., selecting a field, pressing a button, etc), such as selecting a car and causing an inventory level to drop. This change is represented as a change in the browser side model. Depending upon the logic designed by the system designer, the browser side model may, or may not, have authority to accept this change (for example, the browser side model may be coded to verify a US telephone number, but not an international one). If it has the authority, then all of the views on the browser side are updated with the new information. The change is then sent to the server side model so that the server side model is updated. The programmer decides when the server side model is advised of the change. In some cases, for example when filling out an application form, it may be preferable to wait until the entire form is ready for submission to send the updated changes to the server side model. In other cases, it may be important to update the server side model immediately. The system maintains a “changelist” on the browser side to keep track of all the changes made to the model.

As an example, assume that the form of FIG. 3 is set up to sell the inventory in the database. When a user indicates interest in a specific Cadillac model, it causes the browser side model to change, generating a change in the server side model as well. Further assume the system is configured to reserve the item for twenty minutes from the time the user indicates interest at the browser side by setting a reservation in the database. This reservation effects another change in the server side model, which is propagated to the browser side model and translated into the browser side view, indicating to the user the number of Cadillacs in stock and that one unit is reserved for the next twenty minutes.

After the user enters the required information in the desired fields in the correct format, the user clicks on the “Submit” button 62. The browser sends a query containing the search fields entered by the user along with its corresponding change list to the server for processing.

If the user is selecting a car to buy, he is notified of whether the transaction was processed. Clicking the “Submit” button 62 effects a change in the browser side model which checks to see if the request is within the reservation interval of twenty minutes. If it is, the browser side model confirms the purchase, and then sends the purchase information to the server side model, where it is passed through the remaining system software on the server and to the database. If the reservation is not within the interval of twenty minutes, the browser side model indicates that the time has expired and that it must obtain confirmation that the product is still available. This information is propagated to the view, and the request for the purchase is sent to the server side model to confirm availability. Once confirmed, the confirmation is sent back through the server side model, the browser side model and then on to the view.

If the user is merely searching the database for a specific type of car or dealership in his area, the query goes to the server side model and down through the system software to the database. The system software searches the database and retrieves the desired information which is sent to the server side model, then to the browser side model and on to the view.

The separation of concern between the controller, view and model allows construction of logic in the browser without knowing how verification takes place, making the task of constructing a user interface simpler because decisions about where specific processes should be executed can be deferred. In addition, off-line construction of the user interfaces is possible. The user interface designer can use a mock-up model of the server running completely inside the browser making it possible to construct and test a user interface without having access to the full server environment.

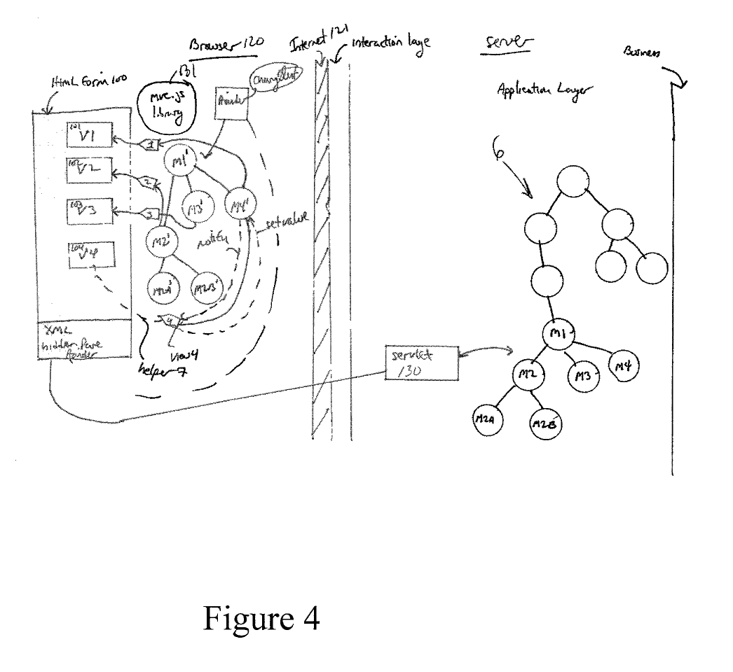

FIG. 4 shows an illustrative system in accordance with the present invention, divided into server side processes 110 and browser side processes 120. An HTML form 100 displayed on a display screen of a user includes fields 101, 102, 103, and 104, which correspond to views 1, 2, 3, and 4 respectively. These fields can be of any of the known varieties, including for example, checkbox, text, radio, buttons, and select. The views 1, 2, 3, and 4 are driven by a browser side model tree having models M1′ through M4′. Each model in the browser side model tree has a corresponding node in the server side model tree 6. When a user directs his or her browser to a location containing HTML form 100, all of the structures on the browser side process 110 are downloaded to his or her computer. At that time, the portion of the server side model 6 which corresponds to the fields 101-104 on the HTML form 100 are downloaded to the browser side model (M1′ through M4′) over the Internet 121. Each view (1-4) is driven by a corresponding model in the browser side model. It should be noted that multiple views can be driven by a single model, but there must be a model corresponding to each view. Moreover, each input or output field on the HTML page is paired with a corresponding view (i.e., there exists a 1:1 relationship between an input or output field and its corresponding view). Communication between the server side processes 110 and browser side processes 120, is handled, on the browser side via an XML document called “hidden pane provider”, and on the server side by an application shown as servlet 130. A library function 131 (for example, called “mvcjs”), preferably coded in the Javascript programming language, includes the requisite functions to facilitate communication from the browser side model to the views 1-4 and input and output boxes 101 through 104, and between the browser side model and the servlet 130. The methods in the library function 131 are invoked from the html form 100.

Among the functions provided by the library function 131 are “helper” methods 7, which facilitate the reading of values from, and writing of values to, the views and their associated input or output boxes on the HTML form 100.

For example, the following method could be used to convert a value from the browser side model into a value which can be displayed in a “checkbox” type view:

TABLE 1A

function CheckboxHelper_fromModel(value)
{
// Boolean ‘true’ or string value “true” means checked.
//
if(value == true)

this.view.checked = true;

else

{
if(value “== true”)

this.view.checked = true;

else

this.view.checked = false;

}

}

In order to store a value from a “checkbox” type view, the following method could be used:

TABLE 1B

function CheckboxHelper_getValue()

{
return this.view.checked;
}

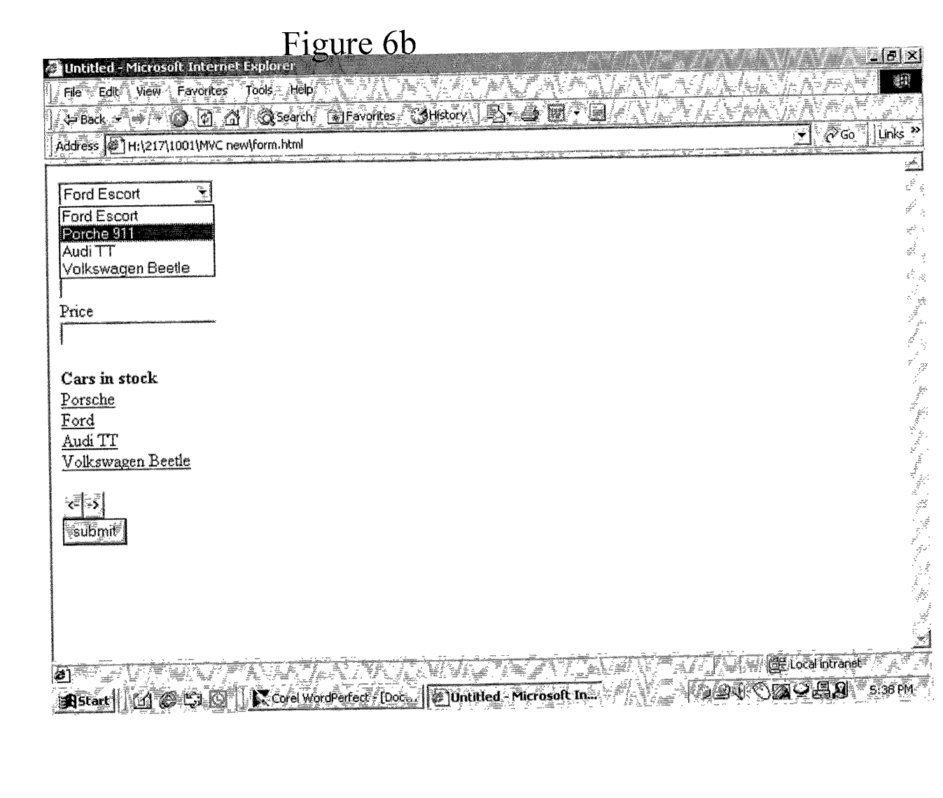

The following is a simple example of an HTML form 100 which uses a library function. The HTML form 100 set forth in Table 2 below (with line numbers inserted on the right for purposes of illustration), generates the web pages shown in FIGS. 6(a) and 6(b):

TABLE 2

| | | Line |
|---|---|---|
| HTML Document | | No. |
| !DOCTYPE HTML PUBLIC“-//W3C//DTD HTML 4.0 | | 1 |
| Transitional//EN”> | | 2 |
| <html> | | 3 |
| <head> | | 4 |
| | <title>Untitled</title> | 5 |
| <script src=mvc.js></script> | | 6 |
| <script> | | 7 |
| function verifyCarPrice(value) | | 8 |
| | { | 9 |
| | if(value > 1000000) | 10 |

| | |
|---|---|
| { | 11 |
| alert(“Price must be lower than 1.000.000”); | 12 |
| return false; | 13 |
| } | 14 |

| | return true; | 15 |
|---|---|---|
| | } | 15 |
| function initForm() | | 16 |
| | { | 17 |
| | // Create a ContainerModel and connect it to a Provider | 18 |
| | // fetching its data from a Servlet using a hidden frame. | 19 |
| | // | 20 |
| document.eonworks.provider = new HiddenFrameProvider(); | | 21 |
| | var carModel = new ContainerModel(“cars/Car”, | 22 |
| document.eonworks.provider); | | 23 |
| | // Set up submodels, i.e. models connected | 24 |
| | // to the input fields | 25 |
| | document.models = new Array(); | 26 |
| | document.models.Car = carModel; | 27 |
| | var modelModel = new Model(“model”); | 28 |
| | carModel.addModel(modelModel); | 29 |
| | modelModel.subscribe(document.forms[0].cars_model); | 30 |
| | var regnrModel = new Model(“regnr”); | 31 |
| | carModel.addModel(regnrModel); | 32 |
| | regnrModel.subscribe(document.forms[0].cars_regnr); | 34 |
| | var priceModel = new Model(“price”); | 35 |
| | carModel.addModel(priceModel); | 36 |
| | priceModel.subscribe(document.forms[0].cars_price); | 37 |
| | priceModel.verify = verifyCarPrice; | 38 |
| | carModel.subscribe(document.forms[0].cars); | 39 |
| | } | 40 |
| </script> | | 41 |
| </head> | | 42 |
| <body onLoad=“initForm()”> | | 43 |
| <form> | | 44 |
| <select name=“cars” id=“cars”> | | 45 |
| | <option value=0>Ford Escort | 46 |
| | <option value=1>Porche 911 | 47 |
| | <option value=2>Audi TT | 48 |
| | <option value=3>Volkswagen Beetle | 49 |

| | |
|---|---|
| </select> | 50 |
| <br>Model<br> | 51 |
| <input id=“cars_model “name=“cars_model”> | 52 |
| <br>Regnr<br> | 53 |
| <input id=“cars_regnr “name”=“cars_regnr”> | 54 |
| <br>Price<br> | 55 |
| <input id=“cars_price” name=“cars_price”> | 56 |
| <br><br> | 57 |
| <b>Cars in stock</b> | 58 |
| <br><a href=“#” | 59 |
| onclick=“document.models.Car.setValue(0)”>Ford</a> | 60 |
| <br><a href“#” onclick=“document.models.Car.setValue(1)” | 61 |
| >Porsche</a> | 62 |
| <br><a href=“#” onclick=“document.models.Car.setValue(2)” | 63 |
| >Audi TT</a> | 64 |
| <br><a href=“#” | 65 |
| onclick=“document.models.Car.setValue(3)”>Volkswagen | 66 |
| Beetle</a> | 67 |
| <br> | 68 |
| <br> | 69 |
| <button name=“back” id=“back” | 70 |
| onClick=“backModel(document.models.Car)”><-</button> | 71 |
| <button name=“forward” id=“forward” | 72 |
| onClick=“forwardModel(document.models.Car)”>-></button> | 73 |
| <br> | 74 |
| <input type=“submit” name=“send” id=“send” value=“submit” | 75 |
| onClick=“document.eonworks.provider.submitChangelist()”> | 76 |
| </form> | 77 |
| </body> | 78 |
| </html> | |

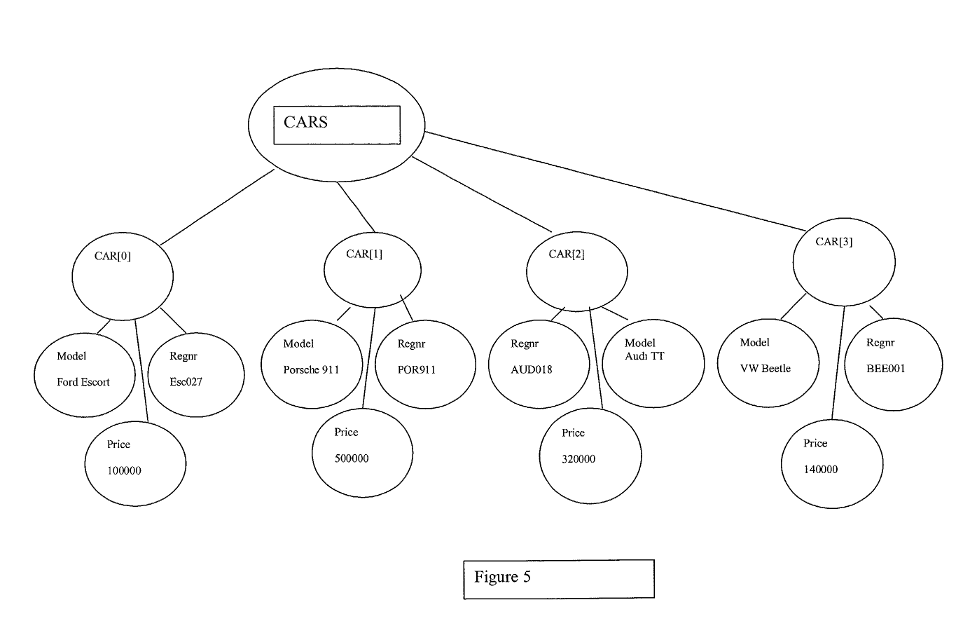

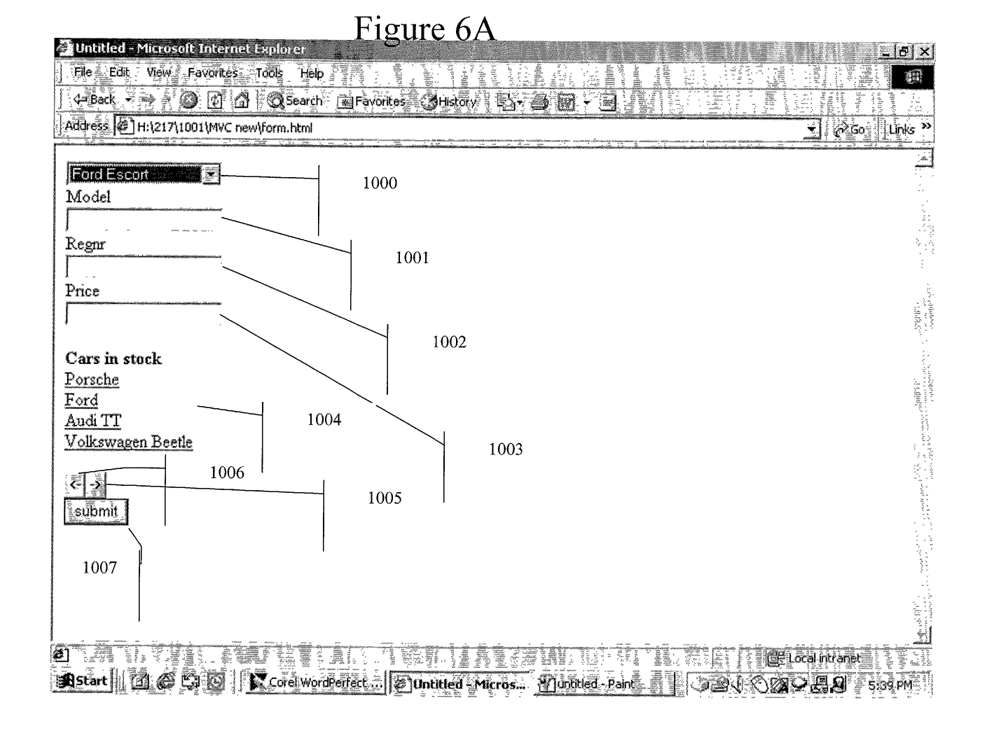

FIG. 5 illustrates an illustrative model for use with this Example. When the web pages of FIGS. 6(a) and 6(b) are downloaded to a browser of the user, the model tree of FIG. 5 is copied from the server side model to a browser side model, initializing the values in the browser side model in the manner shown. Referring to Table 2, lines 16-40 (initForm) defines the initialization method which initializes the browser side model and associates the models in the model tree to the input and output fields on the web page. For example, the input “cars_regnr” is linked to the current “regnr” model (Table, 2, lines 31-34), and the input “cars_price” is linked to the current “regnr” model (which is initialized at cars[0], in accordance with HTML default) which corresponds to the Ford Escort. Referring now to FIGS. 6(a) and 6(b) and Table 2, lines 45 through 50 of Table 2 generate the select menu 1000, and lines 51-57 generate the “Model” input 1001 (cars model), “Regn” input 1002 (cars_regnr), and “Price” input 1003 (cars_price). Because the browser side models shown in FIG. 5 are linked to the inputs 1001 through 1003, if the user types, for example, another value for price into the input 1003 when the current car is car[0], this value will automatically overwrite the initial value of 100,000 in the browser side model. In the preferred embodiment described above, this is implemented by adding the new value to a changelist which is consulted whenever data is requested from the browser side model. By storing the changes in the changelist, rather than in the tree of the browser side model itself, the changes to the browser side model (which are contained in the changelist) can be easily transmitted to the server side model when desired. The “current” Car can be changed either by clicking on the “Cars in Stock” links 1004 (Table 2, lines 58-67), or by using the directional buttons 1005-1006 (Table 2, lines 70-73).

Referring to Table 2, line 60, clicking on the “Porsche” link invokes “document.models.Car.setValue(0)”. The library function includes the following instructions which implement this command, causing the value of the “Car” model to bese to 0.

// Sets a value programatically, i.e. not from a View.
// (Views must use the setViewValue)
//
function Model_setValue(value)

{
this.value = value;
if(this.blockNotify == 0)

this.notifySubscribers();

}
* * *

Model.prototype.setValue = Model_setValue

Referring to Table 2, line 71, clicking on the left arrow 1005 invokes “backModel(document.models.Car)”. The library function includes the following instructions which implement this command, causing the value of the Car model to be decremented:

function backModel(model)

{
model.setValue(model.getValue() − 1);
}

Finally, referring to FIGS. 6(a-b), clicking on the
“submit button” 1007 (Table 2, lines 75-76) invokes
“document.eonworks.provider.submitChangelist()”. The library
function includes the following instructions which implement this
command, causing all changes to the current browser side model to
be sent to the server:

// Converts to XML suitable for sending to an interaction servlet.
//
function ChangeList_toXML()

{
var answer = ‘<?xml version=“1.0” encoding=“UTF-8”?>\n’;
var top = this.changes.length;
// Emit RPC call header
//
answer += ‘<action command“applyChangelist”>\n’;
answer += ‘\t<parameterSet>\n’;
answer += ‘\t\t<scalar name=“targetFrame” value=“form”/>\n’;
answer += ‘\t\t<array name=“values”>\n’;
// Emit names and values
//
for(var idx = 0; idx < top; ++idx)

{
var name = this.changes[idx];
var value = this.changes[name];
answer += ‘\t\t\t<array>\n’;
answer += ‘\t\t\t\t<scalar value=“‘+ name +’” />\n’;
answer += ‘\t\t\t\t<scalar value=“‘+ value[0]+’” />\n’;
answer += ‘\t\t\t\t<scalar value=“‘+ value[1]+’” />\n’
answer += ‘\t\t\t</array>\n’;
}

// Emit footer
//
answer += ‘\t\t</array>\n’;
answer += ‘\t</parameterSet>\n’;
answer += ‘</action>\n’;
return answer;
}

function HiddenFrameProvider_submitChangelist()

{
if(document.eonworks.changeList.size() > 0)

{
var form =

window.parent.frames[“feedback”].document.forms[0];

form.request.value =

document.eonworks.changeList.toXML();

form.submit();
}

// Clear changelist and cache
//
document.eonworks.changeList.clear();
document.eonworks.cache.clear();
}

HiddenFrameProvider.prototype.submitChangelist =
HiddenFrameProvider_submitChangelist;

Referring to the above section of code, the submitChangelist( ) function checks to see if any changes are in the changelist (if(document.eonworks.changeList.size( )>0)). If changes have been made (>0), then the changelist is converted to a format suitable for transmission to the servlet (document.eonworks.changeList.toXML( )), and is transmitted to the servlet 130 over the Internet.

Various other functions can be provided in accordance with the present invention. For example, a cache may be provided on the browser (i.e., coded into the HTML form) to allow models which are not currently linked with views to be maintained on the browser. This allows the views to be reassigned to models in the cache, without requiring access to the server.

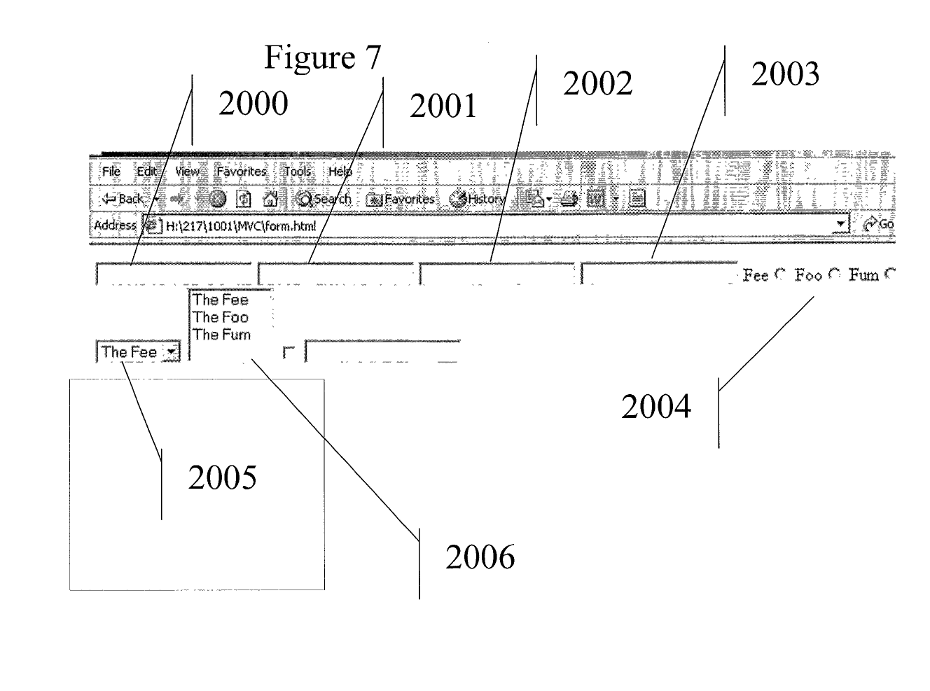

Transformation of data from one view to another can also be implemented. For example, the following code displays the form shown in FIG. 7. The myverify function accepts a string that contains any combination of Fee, Foo, or Fum,. It also accepts one or more semicolons because the format of the multiple selection is “selection-a; selection-b; selection-c.” The occurrences of fee, foo, and fum are replaced with “nothing”, as are the semi-colons. If there is anything left in the string after the removal of the valid items, an error results. In this regard, if the comparison rest.length=0 is true the inputs were correct. If the result is false, the inputs were not correct. The upcaseInputFiler function converts all values input to the “bar” 2000 text fields to upper case, and the lenghtOutputFilter function causes the length of all values input to the form (“value”) to be displayed in “len” 2003 text field. It should be noted that this code assumes that the user only provides input to one of the selections 2000- 2006 of FIG. 7 at any given time.

function upcaseInputFilter(value)

{
return value.toUpperCase();
}

function lengthOutputFilter(value)

{
return value.length;
}

function handleChange(obj)

{
obj.changeHandler();
}

function myVerify(value)

{
var rest = value.toLowerCase();
rest = rest.replace(“fee”, “”);
rest = rest.replace(“foo”, “”);
rest = rest.replace(“fum”, “”);
rest = rest.replace(new RegExp(“;+”), “”);
return rest.length == 0;
}

function initForm()

{
var aModel = new Model();
aModel.subscribe(document.forms[0].foo);
aModel.subscribe(document.forms[0].bar);
aModel.subscribe(document.forms[0].apa);
aModel.subscribe(document.forms[0].len);
aModel.subscribe(document.forms[0].radio);
aModel.subscribe(document.forms[0].selector);
aModel.subscribe(document.forms[0].multiselector);
document.forms[0].bar.inputFilter = upcaseInputFilter;
document.forms[0].len.outputFilter = lengthOutputFilter;
aModel.verify = myVerify;
}

</script>
</head>
<body onLoad=“initForm()”>
<form>
<input type=text id=“bar” name=“bar”>
<INPUT type=text id=“foo” name=“foo”>
<input type=text id=“apa” name=“apa”>
<input type=text id=“len” name=“len”>
Fee<input type=radio value=“Fee” name=“radio” id=“radio”>
Foo<input type=radio value=“Foo” name=“radio” id=“radio”>
Fum<input type=radio value=“Fum” name=“radio” id=“radio”>
<br>
<select name=“selector” id=“selector”>

<option value=“Fee>The Fee
<option value=“Foo”>The Foo
<option value=“Fum”>The Fum

</select>
<select=name=“multiselector” id=“multiselector” multiple>

<option value=“Fee”>The Fee
<option value=“Foo”>The Foo
<option value=“Fum”>The Fum

</select>

The present invention is also directed to any computer readable media having stored thereon the computer executable processes described above, including, without limitation, floppy disks, CD ROMs, tapes, hard disks, and the like.

Although the system and method of the present invention will be described in connection with these preferred embodiments described above, it is not intended to be limited to the specific form set forth herein, but on the contrary, it is intended to cover such alternatives, modifications, and equivalents, as can be reasonably included within the spirit and scope of the invention as defined by the appended claims.

What is claimed is:

1. A system for verifying input between a graphical user interface and a database over a communication network comprising:
a server operably connected to a database, the database maintaining a tree of information in the database, each node in the relational tree constituting a server side model;
a client arranged and constructed to communicate with the server over the communication network, the client having a graphical user interface executable by the computer to:
access the database;
download a mirror copy of at least a portion of the tree, each node in the mirror copy constituting a client side model;
display a form containing one or more fields for receiving and/or displaying information, each field being associated with one of the client side models;
change at least one of the client side models based upon information input to the fields, and
update the server side model with said changes.

2. The system of claim 1, wherein the graphical user interface is a browser.

3. The system of claim 1, wherein the graphical user interface is a windows interface.

4. The system of claim 1, wherein the graphical user interface is a swing interface.

5. The system of claim 1, wherein the graphical user interface is a AWT interface.

6. The system of claim 1, wherein the process is further executable to verify information input to one or more of the fields and navigation of the form by referencing the client side models without communicating with the remote database;

7. The system of claim 1, wherein the process is further executable to maintain a list of changes to the client side models, and to update the server side model with said changes when a submit button is actuated on the form.

8. The system of claim 1, wherein the process is executable process is operable to initialize the client side models with current values of the corresponding server side models when the mirror copy is downloaded.

9. The system of claim 1, wherein the form is an HTML form and the fields input elements selected from the group consisting of a button type, a checkbox type, a radio type, a submit type, and a text type.

10. The system of claim 1, wherein the graphical user interface includes a library utility, the library utility being used by a plurality of forms, the library utility including:
a set of modeling functions for generating the client side model and associating each field on the form with a browser side model;
a set of changelist functions for maintaining a list of changes made to the client side model;
a set of helper functions for converting a value in a client side model to a format suitable for display in a corresponding set of field types; and
wherein a form downloaded by the browser includes instructions which selectively invoke the functions to provide a desired functionality on the form.

11. The system of claim 10, wherein the library utility is composed of functions coded in the JAVA programming language.

12. The system of claim 10, wherein the set of modeling functions includes a subscribe function for associating a client side model with a field on the form.

13. The system of claim 1, wherein a plurality of fields on the form are associated with a single client side model.

14. The system of claim 1, wherein the server includes a process executable to update the client side model with current values of the server side model.

15. A method for verifying input between a graphical user interface and a database over a communication network comprising:
maintaining a tree of information in a database on a server, each node in the relational tree constituting a server side model;
providing a client arranged and constructed to communicate with the server over the communication network, the client having a graphical user interface executable by the computer to:
access the database;
download a mirror copy of at least a portion of the tree, each node in the mirror copy constituting a client side model;
display a form containing one or more fields for receiving and/or displaying information, each field being associated with one of the client side models;
change at least one of the client side models based upon information input to the fields, and
update the server side model with said changes.

16. A computer readable medium, having stored thereon, computer executable process steps operable to:
maintain a tree of information in a database on a server, each node in the relational tree constituting a server side model;
provide a client arranged and constructed to communicate with the server over the communication network, the client having a graphical user interface executable by the computer to:
access the database;
download a mirror copy of at least a portion of the tree, each node in the mirror copy constituting a client side model;
display a form containing one or more fields for receiving and/or displaying information, each field being associated with one of the client side models;
change at least one of the client side models based upon information input to the fields, and
update the server side model with said changes.
